(19) United States
(12) Patent Application Publication
(10) Pub. No.: US 2017/0077629 A1
(43) Pub. Date: Mar. 16, 2017

(54) Combination Tray with Metal Support Plates for Supporting Multiple Memory Cards

(71) Applicant: Motorola Mobility LLC, Chicago, IL (US)

(72) Inventors: Gabriel Ferenczi, Volo, IL (US); Mubeen Ahmed, Lindenhurst, IL (US); Itisha C. Deokar, Buffalo Grove, IL (US); Anjum J. Mirza, Arlington Heights, IL (US); Shaoshu Sha, Evanston, IL (US)

(21) Appl. No.: 14/855,678

(22) Filed: Sep. 16, 2015

(51) Int. Cl. H01R 12/70

(52) U.S. Cl. CPC H01R 12/7076

(57) ABSTRACT

A device includes a tray including first and second support plates and a body having first and second surfaces. A portion of the body electrically isolates the first support plate from the second support plate and a first recess is defined in the body. A circuit board includes first contacts positioned proximate the first recess.

### BACKGROUND

Field of the Disclosure

The disclosed subject matter relates generally to mobile devices and, more particularly, to a combination tray with metal support plates for supporting multiple expansion cards.

Description of the Related Art

Some mobile telephones employ expansion cards, such as a subscriber identity module (SIM) card for storing subscriber identity information, a memory card (e.g., secure digital (SD) card) , a Wi-Fi card, or a combination card (e.g., memory/SIM, Wi-Fi-/SIM, etc.). In some instances, a telephone device may support multiple SIM cards to support multiple subscriber accounts with the same device. For example, each SIM card may be associated with a different country to allow the user to avoid international calling surcharges. Typically, each expansion card is associated with a separate port for receiving the card and a separate connection interface on the phone motherboard. Using multiple ports and connection interfaces consumes valuable real estate on the motherboard, thereby limiting the scaling of the device.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a diagram of a mobile device having a combination memory card tray to support multiple memory cards, according to some embodiments disclosed herein;

FIG. 2 is an exploded perspective view illustrating a top view of the tray of FIG. 1 and example memory cards;

FIG. 3 is a bottom perspective view of the tray of FIG. 1;

FIG. 4 is a perspective view of metal support plates that may be molded into the tray of FIG. 1;

FIG. 5 is a top view of a printed circuit board in the device of FIG. 1; and

FIG. 6 is a top view of the printed circuit board of FIG. 6 with a shroud in place to engage the tray of FIG. 1.

The use of the same reference symbols in different drawings indicates similar or identical items.

### DETAILED DESCRIPTION OF EMBODIMENT(S)

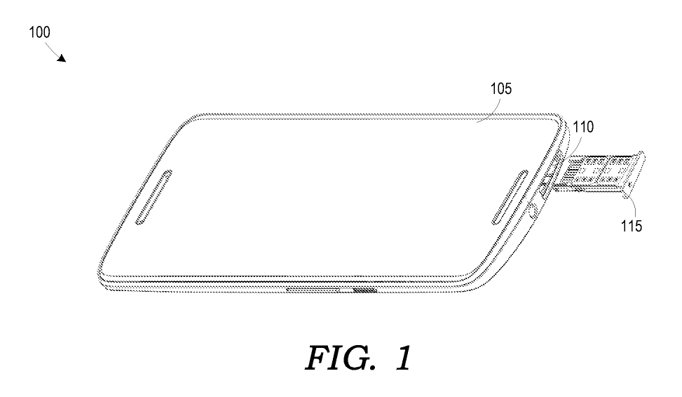

FIG. 1 is a perspective view of one illustrative example of a mobile device 100 disclosed herein. The mobile device 100 includes a casing 105 with a port 110 defined therein for receiving a combination tray 115 that is capable of supporting multiple expansion cards, such as one or more subscriber identity module (SIM) cards for storing subscriber identity information, memory cards (e.g., micro secure digital (uSD) card) for storing data used or generated by the device 100, such as software applications, pictures, music files, etc., Wi-Fi cards, or combination cards that combine multiple expansion types.

In various embodiments, the mobile device 100 may be embodied in a handheld or wearable device, such as a telephone device, a laptop computer, a handheld computer, a tablet computer, a personal data assistants, a music player, a game device, a wearable computing device, and the like. To the extent certain example aspects of the device 100 are not described herein, such example aspects may or may not be included in various embodiments without limiting the spirit and scope of the embodiments of the present application as would be understood by one of skill in the art.

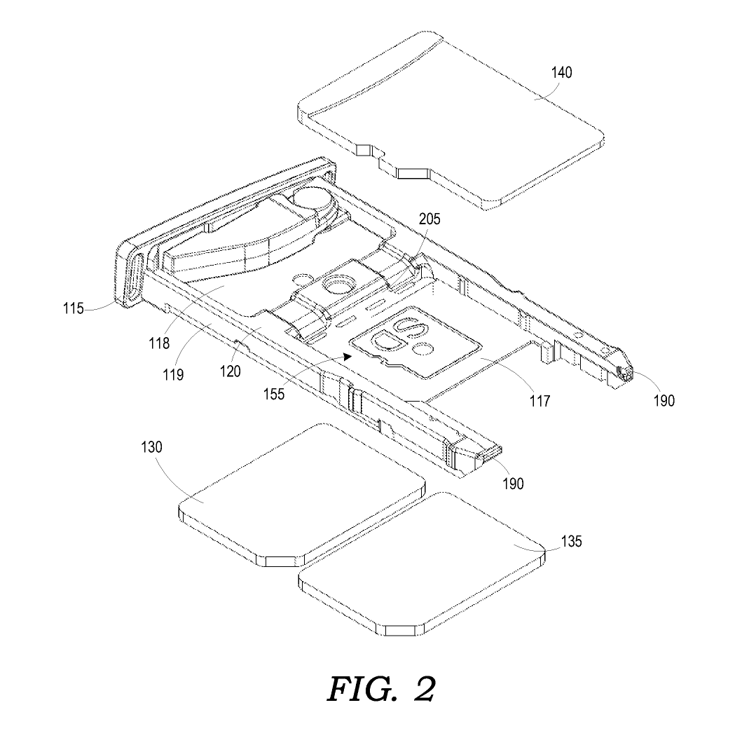

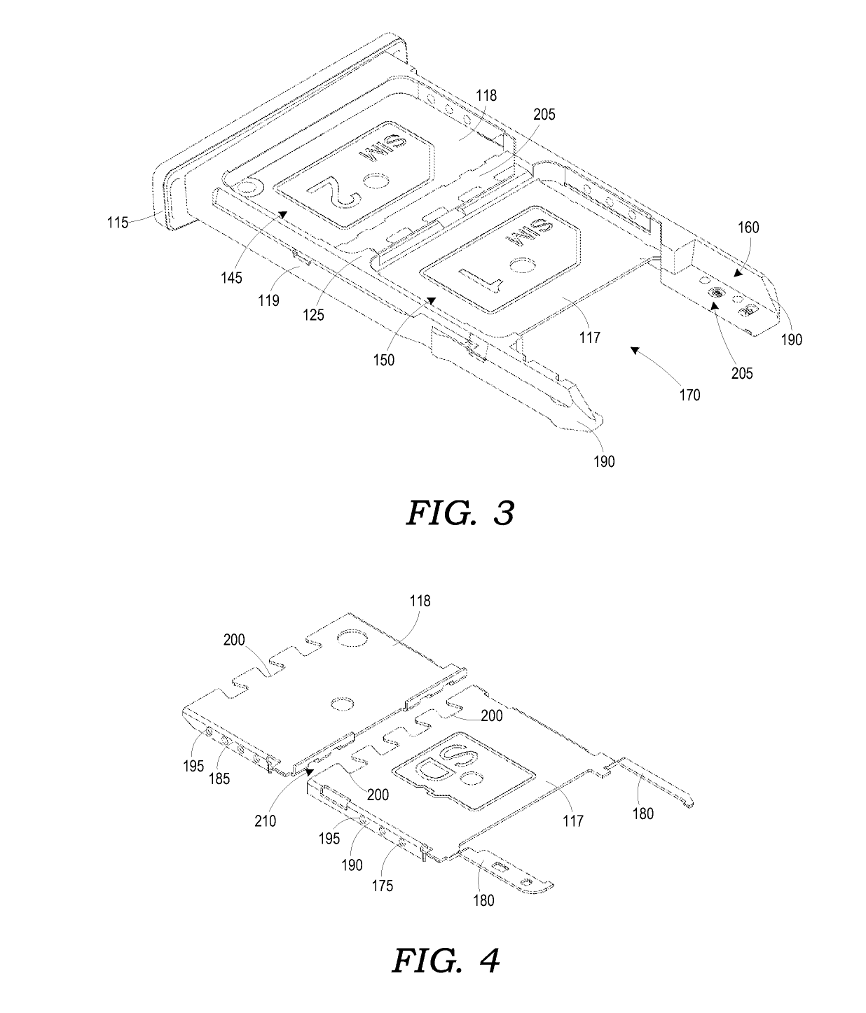

FIGS. 2 and 3 are perspective views of first and second surfaces (e.g., top and bottom surfaces) 120, 125, respectively, of one illustrative example of the combination tray 115. The combination tray includes support plates 117, 118 (e.g., metal support plates), and a molded body 119 (e.g., plastic) encapsulating portions of the support plates 117, 118. In general, the support plates 117, 118 provide enhanced structural support for the molded body 119.

In the illustrated embodiment, the combination tray 115 supports two SIM cards 130, 135 and one uSD card 140. Of course, the particular number of expansion cards and the particular types of expansion cards supported by the combination tray 115 may vary. The combination tray 115 includes first and second recesses 145, 150 defined in the second (e.g., bottom) surface 125 for receiving the SIM cards 130, 135 (see FIG. 3) and a third recess 155 (see FIG. 2) defined in the first (e.g., top) surface 120 for receiving the uSD card 140. The first recess 145 exposes at least a portion of the support plate 118, the second recess exposes at least a portion of the support plate 117, and the third recess 155 exposes another portion of the 117. In some embodiments, the recesses 145, 150, 155 may be slightly smaller than the respective memory cards 130, 135, 140 to provide an interference fit. A fourth recess 160 is also defined in the second (e.g., bottom) surface 125. A window 170 is defined in the combination tray 115 in the third and fourth recesses 155, 160 to expose edge body contacts (not shown) of the uSD card 140 from the second surface 125.

FIG. 4 is a perspective view of the support plates 117, 118 prior to forming the molded body 119. The support plate 117 includes extended arms 180 and upturned edges 190. The support plate 118 also includes upturned edges 185. The support plates 117, 118 provide structural support along a horizontal plane of the combination tray 115, the upturned edges provide structural support along a vertical plane of the combination tray 115, and the arms 180 provide structural support for arm members 190 of the combination tray 115. Holes 195 and notches 200 may be defined in the support plates 117, 118 to allow the material of the molded body 119 to flow though and encapsulate portions of the support plates 117, 118 during the molding process.

The support plates 117, 118 are electrically isolated from one another by a portion 205 (see FIGS. 2 and 3) of the molded body 119 disposed in a region 210 (see FIG. 4). The electrical separation of the support plates 117, 118 reduces noise generated by the operation of the memory cards 130, 135, 140. In the case of the uSD card 140, significant noise is generated during periods of high activity. Such noise could interfere with the transceiver (not shown) of the device 100, thereby reducing its performance.

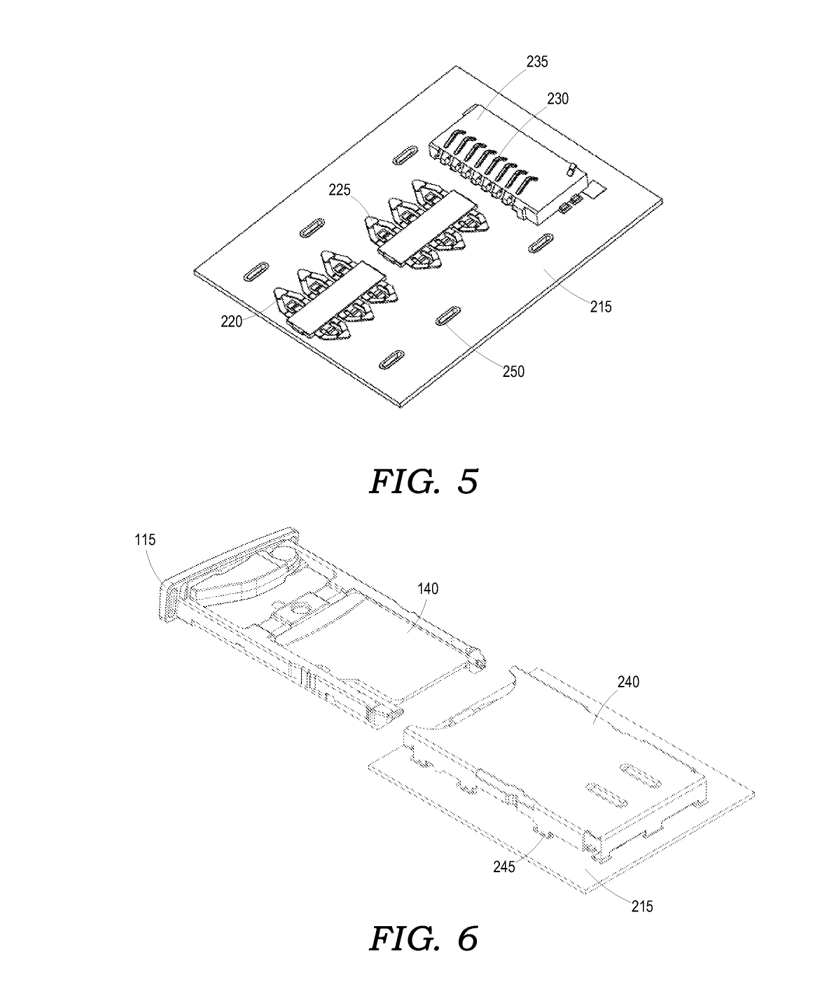

FIG. 5 is a perspective view of a circuit board 215 of the device 100 including contacts 220 for interfacing with the SIM card 130, contacts 225 for interfacing with the SIM card 135, and contacts 230 for interfacing with the uSD card 140 (i.e., through the window 170) when the loaded combination tray 115 is inserted into the port 110 (see FIG. 1). In the illustrated embodiment, the contacts 220, 225, 230 are cantilevered spring contacts, however, other types of contact structures may be employed.

The contacts 230 are supported by a housing 235 that elevates the contacts 230 with respect to the surface of the circuit board 215 to a height greater than that of the contacts 220, 225. Referring to FIG. 2, when the combination tray 115 is engaged with the circuit board 215, the housing 235 is located in the fourth recess 160, and the increased height of the contacts 230 allows then to engage the uSD card 140 through the window 170.

FIG. 6 is a perspective view of the circuit board 215 with a shroud 240 in place above the contacts 220, 225, 230 to define a cavity for receiving the combination tray 115. Tabs 245 defined in the shroud 240 engage corresponding slots 250 defined in the circuit board 215 for mounting the shroud 240.

The combination tray 115 provides a compact mechanism for holding multiple memory cards 130, 135, 140 and allowing the memory cards to be engaged with the circuit board 215 in a common access area using a single port 110. The support plates 117, 118 provide structural support fort the molded body 119, and the electrical separation between the plates 117, 118 reduces noise generated by the memory cards 130, 135, 140.

A device includes a tray including first and second support plates and a body having first and second surfaces. A portion of the body electrically isolates the first support plate from the second support plate and a first recess is defined in the body. A circuit board includes first contacts positioned proximate the first recess.

A device includes a circuit board having first contacts, a casing coupled to the circuit board, the casing partially defining a port that exposes a portion of the circuit board, and a tray removably positioned proximate the circuit board through the port. The tray includes first and second support plates and a body having first and second surfaces. A portion of the body electrically isolates the first support plate from the second support plate and a first recess is defined in the body. The first contacts are positioned proximate the first recess.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

1. A device, comprising:
a removable tray, comprising:
first and second electrically conductive support plates, wherein the first and second electrically conductive support plates are coplanar; and
a body having first and second surfaces, wherein a portion of the body is disposed between the first and second electrically conductive support plates to electrically isolate the first electically conductive support plate from the second electrically conductive support plate and a first recess is defined in the body; and
a circuit board comprising first contacts positioned proximate the first recess.

2. The device of claim 1, further comprising an expansion card positioned in the first recess.

3. The device of claim 1, wherein the first recess exposes a portion of the first electrically conductive support plate.

4. The device of claim 1, wherein the tray further comprises a second recess defined in the first surface and a window defined in the first and second recesses, wherein the first contacts are positioned proximate the window.

5. The device of claim 4, wherein the tray further comprises a third recess defined in the second surface, and the circuit board comprises second contacts positioned proximate the third recess.

6. The device of claim 5, wherein the third recess exposes a portion of the second electrically conductive support plate.

7. The device of claim 5, further comprising a housing supporting the first contacts, wherein the housing is positioned in the second recess.

8. The device of claim 7, wherein the housing elevates the first contacts above the circuit board to a height greater than that of the second contacts.

9. The device of claim 1, wherein the tray further comprises a second recess defined in the second surface, the circuit board comprises second contacts positioned proximate the second recess, and the device further comprises a memory card positioned in the first recess and a subscriber identity module (SIM) card positioned in the second recess.

10. The device of claim 1, further comprising a shroud mounted to the circuit board and defining a cavity for receiving the tray.

11. A device, comprising:
a circuit board comprising first contacts;
a casing coupled to the circuit board, the casing partially defining a port that exposes a portion of the circuit board; and
a tray removably positioned proximate the circuit board through the port, the tray comprising:
first and second electrically conductive support plates wherein the first and second electrically conductive support plates are coplanar; and
a body having first and second surfaces, wherein a portion of the body is disposed between the first and second electrically conductive support plates to electrically isolate the first electrically conductive support plate from the second electrically conductive support plate, a first recess is defined in the body, and the first contacts are positioned proximate the first recess.

12. The device of claim 11, further comprising an expansion card positioned in the first recess.

13. The device of claim 11, wherein the first recess exposes a portion of the first electrically conductive support plate.

14. The device of claim 11, wherein the tray further comprises a second recess defined in the first surface and a window defined in the first and second recesses, wherein the first contacts are positioned proximate the window.

15. The device of claim 14, wherein the tray further comprises a third recess defined in the second surface, and the circuit board comprises second contacts positioned proximate the third recess.

16. The device of claim 15, wherein the third recess exposes a portion of the second electrically conductive support plate.

17. The device of claim 15, further comprising a housing supporting the first contacts, wherein the housing is positioned in the second recess.

18. The device of claim 17, wherein the housing elevates the first contacts above the circuit board to a height greater than that of the second contacts.

19. The device of claim 11, wherein the tray further comprises a second recess defined in the second surface, the circuit board comprises second contacts positioned proximate the second recess, and the device further comprises a memory card positioned in the first recess and a subscriber identity module (SIM) card positioned in the second recess.

20. The device of claim 11, further comprising a shroud mounted to the circuit board and defining a cavity for receiving the tray.

21. A device, comprising:
a removable tray, comprising:
first and second support plates; and
a body having first and second surfaces, wherein a portion of the body is disposed between the first and second support plates to electrically isolate the first support plate from the second support plate, and first and second recesses are defined in the body;
a circuit board comprising first contacts positioned proximate the first recess and second contacts positioned proximate the second recess;
a memory card positioned in the first recess; and
a subscriber identity module (SIM) card positioned in the second recess, wherein the second recess is disposed in the second surface.

22. The device of claim 21, wherein the first recess exposes a portion of the first support plate.

23. The device of claim 21, wherein the tray further comprises a third recess defined in the first surface and a window defined in the first and third recesses, wherein the first contacts are positioned proximate the window.

24. The device of claim 21, wherein the second recess exposes a portion of the second support plate.

25. The device of claim 21, further comprising a housing supporting the first contacts, wherein the housing is positioned in the second recess.

26. The device of claim 25, wherein the housing elevates the first contacts above the circuit board to a height greater than that of the second contacts.

27. The device of claim 21, further comprising a shroud mounted to the circuit board and defining a cavity for receiving the tray.
